(19) United States
(12) Patent Application Publication
(10) Pub. No.: US 2014/0305530 A1
(43) Pub. Date: Oct. 16, 2014

(54) EXPANDING MEDICAL DEVICE FORMED OF SLOTTED METAL TUBE

(71) Applicant: Calore Medical Ltd., Yokneam (IL)

(72) Inventors: Giora Kornblau, Binyamina (IL); David Maier Neustadter, Moshav Nof Ayalon (IL)

(73) Assignee: Calore Medical Ltd., Yokneam (IL)

(21) Appl. No.: 14/250,716

(22) Filed: Apr. 11, 2014

Related U.S. Application Data
(60) Provisional application No. 61/811,743, filed on Apr. 14, 2013.

(51) Int. Cl. F16L 11/00

(52) U.S. Cl. CPC F16L 11/00
USPC 138/118

(57) ABSTRACT

A slotted metal tube includes a wall with multiple slots cut through it wherein the slots and the bands between the slots are configured such that when an axial compression force is applied to the ends of the tube the bands expand outwards and form an overlapping flower petal pattern as the ends of the tube come closer together.

### REFERENCE TO RELATED APPLICATIONS

This application claims priority from U.S. Provisional Patent Application No. 61/811,743 entitled Expanding medical device formed of slotted metal tube, which is incorporated herein by reference in its entirety.

### BACKGROUND

There exist many examples of expanding medical devices, used as stents, anchors, occluders, filters, baskets, artery locators, and similar functions which can be inserted into the body in a collapsed configuration and expanded once inside the body. Many such devices are made of metal wire or cut metal tubes. These different types of expanding devices expand in different ways depending on their intended use. Some, such as stents, expand by changing only the diameter of the tube, while others, such as filters, anchors, artery locators, and occluders, change their geometry entirely as they expand.

When attempting to change a narrow tube into a flattened disc, such as anchors, artery locators, and occluders, there exist mechanical limitations that limit the use of cut metal tubes and favor the use of metal wires. Metal wires can be arranged to lie flat when expanded, forming a geometry similar to the overlapping petals of a flower, as described in U.S. Pat. No. 8,366,706, a geometrical transformation which may not be easily be achieved by a cut metal tube.

A number of configurations of expandable cut metal tubes have been previously described which form metal loops when expanded. For example, U.S. Pat. No. 8,568,445 describes spiral cuts in the wall of a tube which form struts that expand into loops or petals when compressed. U.S. Pat. No. 8,252,022 describes lengthwise or spiral cuts in a tube which form expansion members that expand transversely when compressed longitudinally. However, as highlighted by the figures of the expanded form in each of the descriptions, they tend not to form loops that overlap each other like the overlapping petals of a flower.

This overlapping petal pattern may produce a sturdy disc-shaped structure that, when covered by an elastic membrane, provides better mechanical support and sealing performance than non-overlapping loops or petals. The overlapping petal pattern may provide increased sturdiness while providing a large diameter disc relative to the length of the device when in its collapsed configuration. In some embodiments of intravascular anchors or artery locators of a vascular closure device, the collapsed length to expanded diameter ratio may prove particularly important.. A vascular closure device anchor or artery locator is generally inserted into the blood vessel, expanded, pulled gently against the inner wall of the vessel, held in place during the closure procedure, and then re-collapsed and removed. In some embodiments, the anchor should be sturdy enough and have a large enough diameter when expanded to remain firmly within the vessel, yet be short enough when collapsed so that it does not injure the vessel wall upon re-collapse at the end of the procedure, when it is oriented sideways across the diameter of the vessel.

Some existing wire-based overlapping petal pattern may be expensive to manufacture. If an equivalent geometrical configuration could be achieved by a cut metal tube, it could provide a significant reduction in manufacturing costs.

### SUMMARY

An object of some of the embodiments contained in the present disclolsure is to provide a slotted metal tube which, upon the application of an axial compressive force, expands radially such that the bands between the slots of the tube bend in such a way that they form an overlapping flower petal pattern.

Another such object may be to provide a slotted metal tube which, upon the application of an axial compressive force, expands radially such that the relationship between its collapsed length ‘l’, its collapsed diameter ‘d’, and its expanded diameter D′ are such that l−(D−d)<25 times the wall thickness of the tube.

### BRIEF DESCRIPTION OF THE DRAWINGS

Aspects of the present disclosed embodiments will become more fully understood from the detailed description given herein below and the accompanying drawings which are given by way of illustration only, and thus are not limitative of the present invention, and wherein:

FIG. 1A is a view of a slotted tube of an embodiment of the invention in its collapsed state indicating the dimensions ‘l’ and ‘d’, the length and diameter, respectively, of the tube in its collapsed state.

FIG. 1B is a view of a slotted tube of an embodiment of the invention in its expanded state indicating the dimension ‘D’, the diameter of the tube in its expanded state.

FIG. 2 is a cross-section view of a slotted tube of an embodiment of the invention indicating components of the device and the angle between them.

FIG. 3A is a view of a slotted metal tube in its collapsed state according to one embodiment of the invention.

FIG. 3B is a view of an overlapping flower petal like configuration of an expanded tube of an embodiment of the invention.

### DETAILED DESCRIPTION OF THE PREFERRED EMBODIMENTS

In this description the term “long axis of the tube” is used to mean a direction that is within 20 degrees of the direction of the line connecting the center points of the ends of the expanding slotted metal tube.

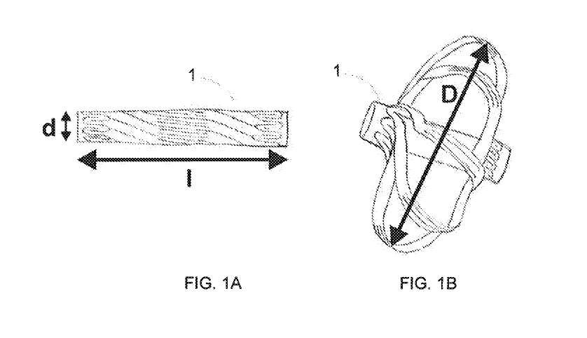

Referring to FIG. 1A and FIG. 1B, there is shown a slotted metal tube 1 in its collapsed (FIG. 1A) and expanded (FIG. 1B) configurations. The collapsed length ‘l’, collapsed outer diameter ‘d’, and expanded diameter ‘D’ are indicated in FIG. 1A and FIG. 1B.

Some embodiments of the invention include an expanding slotted metal tube with collapsed length ‘l’, collapsed outer diameter ‘d’, and expanded diameter ‘D’, such that l−(D−d)<25 times the wall thickness of the tube.

Some embodiments of the invention include an expanding slotted metal tube with collapsed length ‘l’, collapsed outer diameter ‘d’, and expanded diameter ‘D’, such that l<7 mm, d<1.5 mm, and D>4.5 mm.

Some embodiments of the invention include an expanding slotted metal tube having metal bands between the slots.

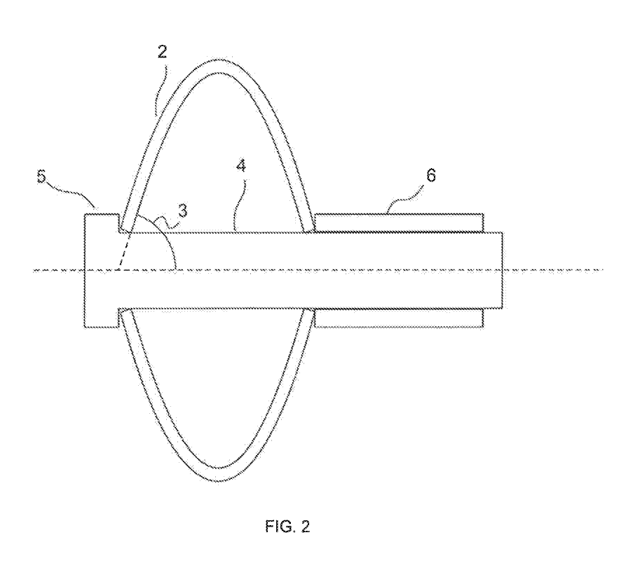

FIG. 2 shows a cross-section view of a slotted metal tube in an expanded configuration. Metal band 2 is shown to be bent and to form an angle 3 with the long axis of the tube at its ends.

Some embodiments of the invention include an expanding slotted metal tube 1 with bands 2, the ends of which, when expanded, form an angle 3 between 45 and 135 degrees, or between 60 and 120 degrees, or between 70 and 100 degrees, with the long axis of the tube.

In some embodiments of the invention the widths of some locations along the lengths of the bands and the patterns at the ends of the tube are designed to induce the device to preferentially bend in a predefined way when force is applied to the ends of the device along the long axis of the tube.

In some embodiments of the invention the widths of some locations along the lengths of the bands and the patterns at the ends of the tube are designed to allow the device to bend sufficiently to achieve its intended expanded shape without breaking.

In some embodiments of the invention the widths of some locations along the lengths of the bands and the patterns at the ends of the tube are designed to allow the device to bend sufficiently to achieve its intended expanded shape while all deformations remain substantially elastic.

In some embodiments of the invention the expanding slotted metal tube 1 is not connected to the other components of the device of which it forms a part, but rests upon a support element 4, as seen in FIG. 2, which is composed of a wire or tube which fits through the expanding slotted metal tube.

In some embodiments of the invention the support element 4 upon which the expanding slotted metal tube rests has at its distal end a section 5 which has a diameter larger than the inner diameter of the expanding slotted metal tube in its collapsed configuration such that when the support element is pulled in the proximal direction through the expanding slotted metal tube it applies a force on the distal end of the expanding slotted metal tube in the proximal direction along the long axis of the tube.

In some embodiments of the invention there is a sleeve 6 around the support element, proximal to the expanding slotted metal tube, which has an outer diameter larger than the inner diameter of the expanding slotted metal tube in its collapsed configuration such that when the support element is pulled in the proximal direction through the expanding slotted metal tube and through the sleeve, the sleeve applies a force on the proximal end of the expanding slotted metal tube in the distal direction along the long axis of the tube.

Some embodiments of the invention include an expanding slotted metal tube as described in previous embodiments such that the deformations that occur during expansion are substantially plastic in nature and the device therefore remains substantially in its expanded configuration even after the expanding forces are removed.

Some embodiments of the invention include an expanding slotted metal tube as described in previous embodiments such that the deformations that occur during expansion are substantially elastic in nature and the device therefore returns substantially to its original collapsed tubular configuration when the expanding forces are removed.

In some embodiments of the invention the expanding slotted metal tube is made of a non-superelastic metal.

In some embodiments of the invention the expanding slotted metal tube is made of a superelastic metal, such as a Nickel-Titanium alloy.

In some embodiments of the invention the slots in the expanding slotted metal tube that define the bands which expand to form the disc are substantially parallel with the long axis of the tube.

Some embodiments of the invention include an expanding slotted metal tube designed such that when expanded by applying a force along the long axis of the tube from both ends, the bands between the slots of the tube remain substantially parallel to the long axis of the tube and bend primarily in the radial direction to expand radially outwards as the ends of the tube come closer together.

Some embodiments of the invention include an expanding slotted metal tube designed such that when expanded by applying a force along the long axis of the tube from both ends, the bands between the slots of the device twist such that their bending is in both the radial and circumferential directions forming an overlapping flower petal pattern as the ends of the tube come closer together.

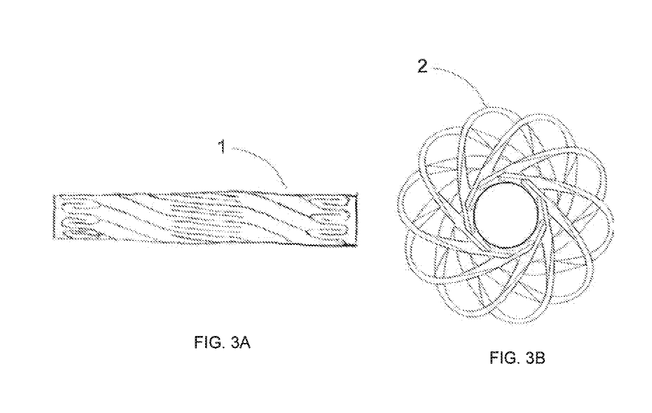

FIG. 3A shows a slotted metal tube according to one embodiment of the invention and FIG. 3B shows the overlapping petal pattern formed by the bands of the expandable slotted metal tube in its expanded configuration.

FIG. 3A shows a cut pattern of one embodiment of the invention in which the cuts include multiple sections, each with a different angle relative to the long axis of the tube.

In some embodiments, the proximal, distal, and middle sections contain cuts that are substantially parallel with the long axis of the tube, but shifted around the tube relative to each other. The portions of the cuts that connect the proximal and middle sections and the middle and distal sections are angled relative to the long axis of the tube.

Cut patterns including multiple sections with different angles relative to the long axis of the tube produce bands with mechanical properties and behavior superior to those obtained by previously described parallel or spiral cut patterns.

In some embodiments of the invention which expand to form an overlapping petal pattern the thickness of the bands and the thickness of the cut patterns in the proximal and distal sections of the tube are such that the twisting that allows the bands to bend in the circumferential direction takes place primarily in the bands and not in the region of the patterns in the proximal and distal sections of the tube.

In some embodiments of the invention which expand to form an overlapping petal pattern the thickness of the bands and the thickness of the patterns in the proximal and distal sections of the tube are such that the twisting that allows the bands to bend in the circumferential direction takes place primarily in the region of the patterns in the proximal and distal sections of the tube and not in the bands themselves.

Some embodiments of the invention include an expanding slotted metal tube covered by an elastic material such that when expanded by applying a force along the long axis of the tube from both ends of the device the elastic material is stretched between the bands. The elastic material can be silicon or Polyblend or Chronoprene (AdvanSource Biomaterials, Wilmington, Mass.) or any similar elastic material that has appropriate elasticity and strength to stretch over the tube in its expanded configuration and return to its original dimensions when the tube returns to its compressed configuration.

We claim:

1) A slotted metal tube comprising a wall with multiple slots cut through it wherein the slots and the bands between the slots are configured such that when an axial compression force is applied to the ends of the tube the bands expand outwards and form an overlapping flower petal pattern as the ends of the tube come closer together

2) The metal tube of claim 1 in which the dimensions of the tube are such that given a collapsed length ‘l’, collapsed outer diameter ‘d’, and expanded diameter ‘D’, l−(D−d)<25 times the wall thickness of the tube

3) The metal tube of claim 1 in which said collapsed length ‘l’ is less than 7 mm, said collapsed outer diameter ‘d’ is less than 1.5 mm, and said expanded diameter ‘D’ is greater than 4.5 mm

4) The metal tube of claim 1 which expands from its collapsed configuration to its expanded configuration while all deformations remain elastic deformations

5) The metal tube of claim 1 wherein the multiple slots are each comprised of multiple sections whose cuts are at different angles relative to the long axis of the tube
